(19) United States
(12) Patent Application Publication
(10) Pub. No.: US 2011/0290085 A1
(43) Pub. Date: Dec. 1, 2011

(54) Dual Hex Pattern Open End Wrench

(76) Inventors: Perry James Richardson, Los Gatos, CA (US); Bruce J. Richardson, Los Gatos, CA (US)

(21) Appl. No.: 13/102,025

(22) Filed: May 5, 2011

Related U.S. Application Data
(63) Continuation-in-part of application No. 12/960,516, filed on Dec. 5, 2010.
(60) Provisional application No. 61/349,811, filed on May 28, 2010.

(51) Int. Cl. B25B 13/02

(52) U.S. Cl. 81/119

(57) ABSTRACT

An open ended wrench incorporating both English (inch) and metric sizes. Two conventional single-size wrenches are replaced by a dual-size hex pattern wrench, reducing the number of wrenches likely to be needed to do a job. One hex pattern is sized to match preferably a metric component and the other hex pattern is sized to match preferably an English component. The two different sized hex patterns are preferably offset by 30 degrees.

This application is a continuation-in-part of U.S. application Ser. No. 12/960,516, filed Dec. 5, 2010, which claims the benefit of U.S. Provisional Application No. 61/349,811, filed May 28, 2010.

### BACKGROUND OF THE INVENTION

1. Technical Field

The present invention relates generally to hand tools, and more particularly to open end or combination end wrenches.

2. Discussion of Prior Art

Conventional wrenches for turning a hexagonal nut have faces to bear on each of at least the two opposite sides of the nut. FIG. 1 illustrates a typical prior art combination end wrench 10, having a handle 13 and open end slots 12 and 14. The open slots 12 and 14 are typically different sizes. The slots 12 and 14 contact and apply force to the surface around about two-thirds of the periphery of a hexagonal nut.

Automobiles often are assembled from components that are manufactured in many different countries. Some countries utilize the inch system and others the metric system for measuring bolt sizes. Many machines are assembled with both metric and English sized nuts and bolts. A conventional hand driven inch or metric sized wrench is made to fit only one specific size nut or bolt. This has obliged mechanics, machinists, electricians and consumers to purchase a large number of individual wrenches to make up a tool set that will accommodate different jobs involving inch and metric hardware.

U.S. Pat. No. 5,048,379 shows double-ended sockets with an internal axially central square drive well, accessible from either open socket end by a conventional extension rod for driving the tools. However, this patent requires the removal, rotation, and replacement of the socket to change from inch to metric size. This patent also requires an extension or a special driving wrench to operate.

In addition to the large number of wrench sizes needed, mechanics or other persons proceeding to install or remove nuts and bolts are often uncertain of the precise size and, by eyeballing the nut, guess which size wrench to use. Further, when servicing an automobile it is often difficult to determine whether a bolt is inch or metric. Commonly, the mechanic needs to try wrenches until he or she discovers the correct sized wrench for the bolt or nut of interest. It may take a few tries to discover whether the bolt is metric or inch, and the size required. If they choose wrongly and their choice is smaller, the wrench will of course not fit. If their wrong choice is larger but not too much the wrench will fit loosely. If both the wrench and the nut are made of material that is hard enough to withstand the application of applied turning forces then this will turn the nut, but if either material (usually the nut) is not strong enough, then there is an increased chance that the mismatch will round off the vertices of, and ruin, (usually) the nut.

### SUMMARY OF THE INVENTION

The present invention provides a wrench that accommodates two sizes of nuts and bolts, and thereby reduces the total number of wrenches required for assembly and disassembly of various sizes nuts and bolts. Wrenches configured according to the invention reduce the time required to determine the correct sized wrench for a particular nut or bolt. It does this by combining sizes that, while different, differ by only small amounts.

Standard English sizes of wrenches considered alone are spaced far apart, or differ, enough to limit opportunities for making an inner hex pattern of the next smaller size than an outer pattern. Standard metric sizes of wrenches are spaced similarly far apart. However, considering the range of English sizes side-by-side with the range of metric sizes, there are numerous couples of English and metric sizes that are only slightly different. This is a very cause of confusion over correct sizes as discussed in the Background section. The present invention takes advantage of the fact that a 12 point wrench could accommodate two slightly different nut sizes. One of the hex patterns could be sized to match a metric component and the other hex pattern sized to match an inch component. These two different sized hex patterns enable the user to use one wrench for the two different sizes of hexagonal nuts.

The present invention in a preferred embodiment provides a wrench for turning hexagonal nuts and bolts, having a jaw with a center axis and, around the axis, a partial cylindrical opening which has, intersected by a plane perpendicular to the axis, some sides along the perimeter of a first, larger size hexagon, and other sides along the perimeter of a second, smaller size hexagon which is offset around the axis from the first hexagon.

Among its advantages the dual function open wrench reduces the number of times a user has to change tools and thereby allows faster repairs.

### BRIEF DESCRIPTION OF THE DRAWING

FIG. 1 is an isometric view of a prior art open end wrench;

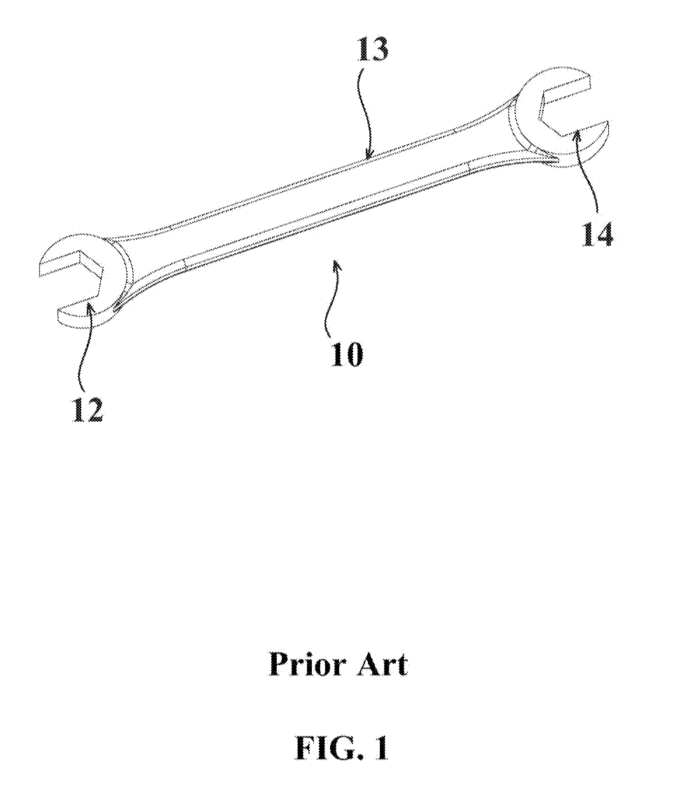

FIG. 2 is an isometric view of an open end dual-size double hex wrench according to an embodiment of the present invention;

FIG. 3 is an end view of the FIG. 2 wrench identifying features of two different size outer and inner hex patterns;

FIG. 4 is another end view of the FIG. 2 wrench identifying dimensions of the two different size large and small hex patterns;

FIG. 5 is a table listing, in Column A English sizes in fractions of an inch for an outer hex pattern, in Column D metric sizes under consideration for an inner hex pattern, and in Column J indicating with a check mark if the combination is preferred;

FIG. 6 is a table listing, in Column A metric sizes for an outer hex pattern, in Column D English sizes under consideration for an inner hex pattern, and in Column J indicating with a check mark if the combination is preferred;

FIG. 7 is a table similar to FIG. 5 but evaluating maximum and minimum size English sizes for an inner hex pattern;

FIG. 8 is a table similar to FIG. 6 but evaluating maximum and minimum size metric sizes for an inner hex pattern;

FIG. 9 is an end view of a dual-size double hex open end wrench according an embodiment having an outer hex size H1= 11/16″ and an inner hex size H2=17 mm, used with the 11/16″ hex size mismatched to a 17 mm nut with surface contact area increased over an all 11/16″ prior art wrench; and

FIG. 10 is a diagram showing the theoretical limit for the reduction in size for an inner hex pattern.

### DETAILED DESCRIPTION OF THE INVENTION

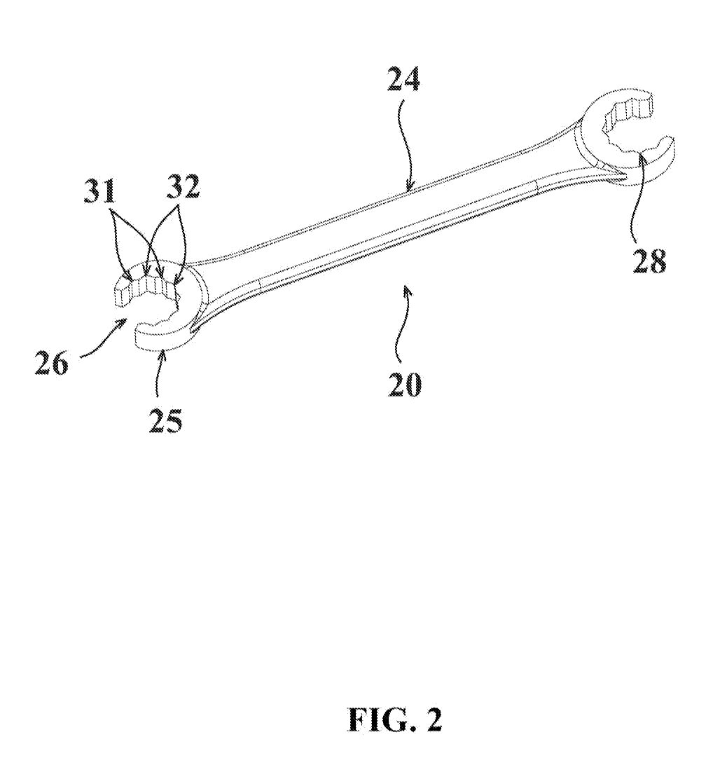

FIG. 2 is an isometric view of an open end wrench 20 according to an embodiment of the invention. Wrench 20 comprises a handle 24 having an outside surface with a preferably generally oval cross-section, although other shapes are possible. The handle 24 at its left end 25 has a nut opening 26. Handle 24 delivers torque to the outer hex pockets 31 and the inner hex pockets 32. Other types and shapes of drive pockets could be used.

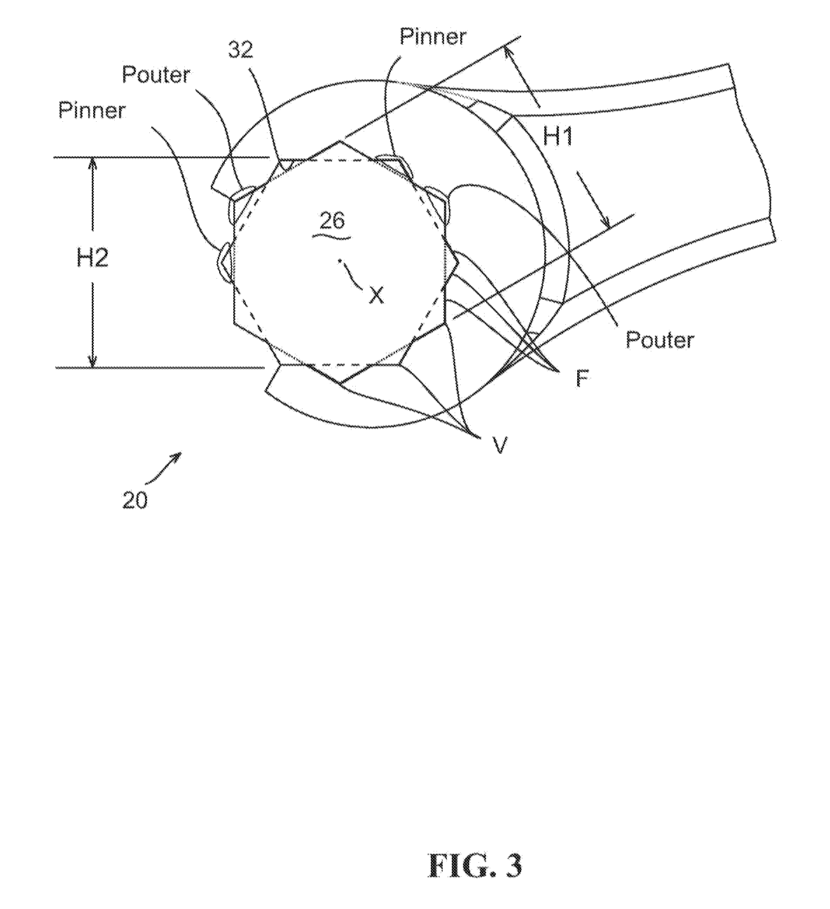

As shown in FIG. 3 the nut opening 26 is centered around a rotational axis X and bounded by an inside surface 32 having preferably 18 facets F in planes parallel to the axis. Adjacent facets intersect in alternately positive (CW 60°) and negative (CCW 30°) angles. Each positive angle vertex V and its adjacent facets form a pocket P. A first set of pockets Pouter including every other pocket defines the boundaries of a first hexagonal pattern H1 (pockets connected by dashes). A second set Pinner of the alternate pockets defines the boundaries of a second hexagonal pattern H2 (pockets connected by dots). In a conventional single-size wrench the two hexagonal patterns are of equal sizes and offset by 30° around axis X; in a wrench according to the invention the two hexagonal patterns H1 and H2 are of different sizes to accommodate different sized nuts.

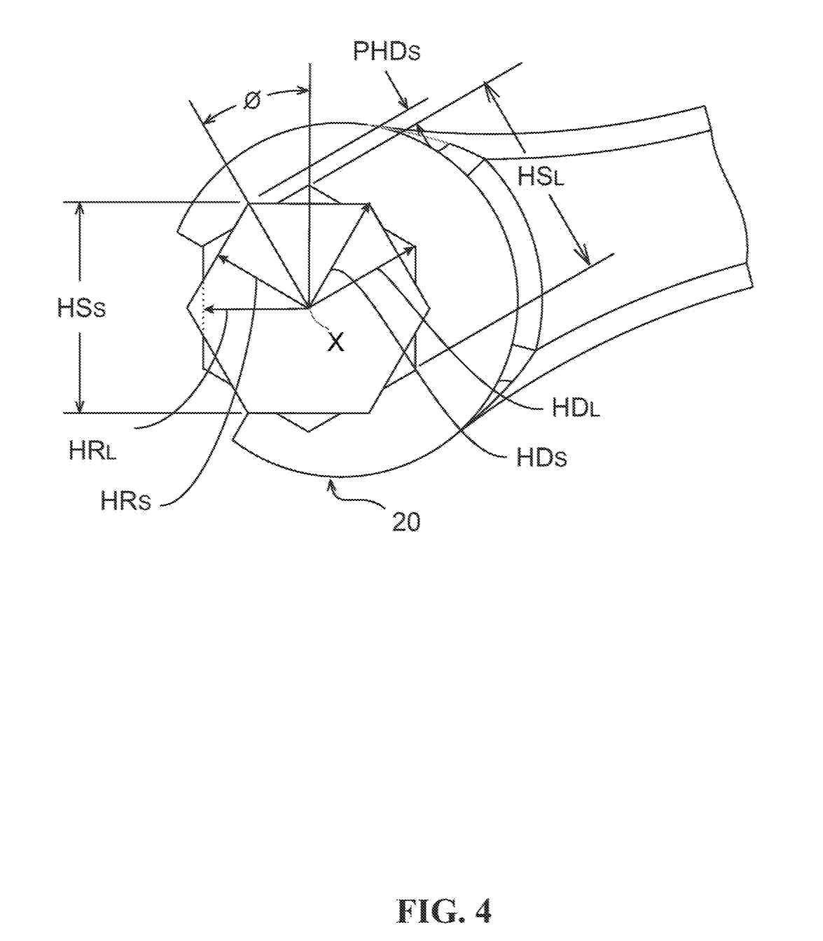

FIG. 4 identifies dimensions of a larger, outer, first hex size HSL and a smaller, inner, second hex size HSs in a wrench 20 according to an embodiment of the invention. The two hex patterns are preferably offset by ø=30° around axis X.

Large Hex Pattern

Hex Size Large=HSL

Hex Radius Large=HRL

Hex Diagonal Large=HDL

Point Hex Distance Large=PHDL (not shown)

Small Hex Pattern

Hex Size Small=HSs

Hex Radius Small=HRs

Hex Diagonal Small=HDs

Point Hex Distance Small=PHDs

The nominal sizes of the accommodated hex nuts, larger hex size HSL and smaller hex size HSs, yield further dimensions as follows:

The Hex Radius HR is half the overall Hex Size HS (i.e., face-to-face diameter).

HR=½*HS

For each pattern the Point-to-Hex Distance PHD is that pattern's Hex Diagonal HD minus the alternate pattern's Hex Radius HR:

For the larger, outer hex pattern H1;

HDL=HRL/cos 30°

PHDL=HDL−HRs

For the smaller, inner hex pattern H2;

HDs=HRs/cos 30°

PHDs=HDs−HRL

The Surface Contact lengths for the large and small hex sizes are:

SCL=PHDL/sin 30°

SCs=PHDs/sin 30°

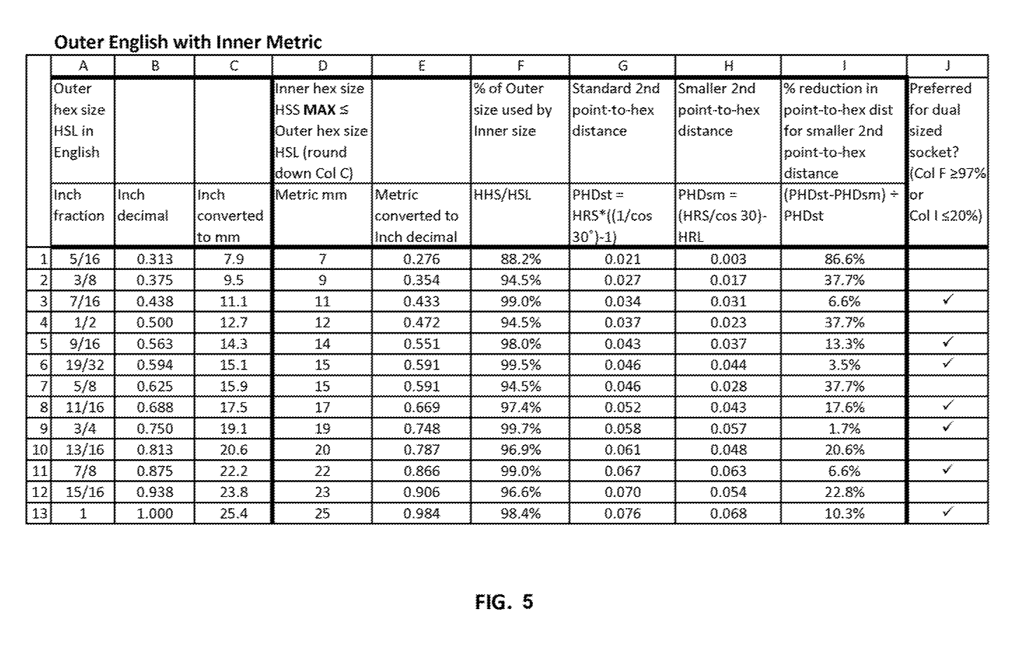

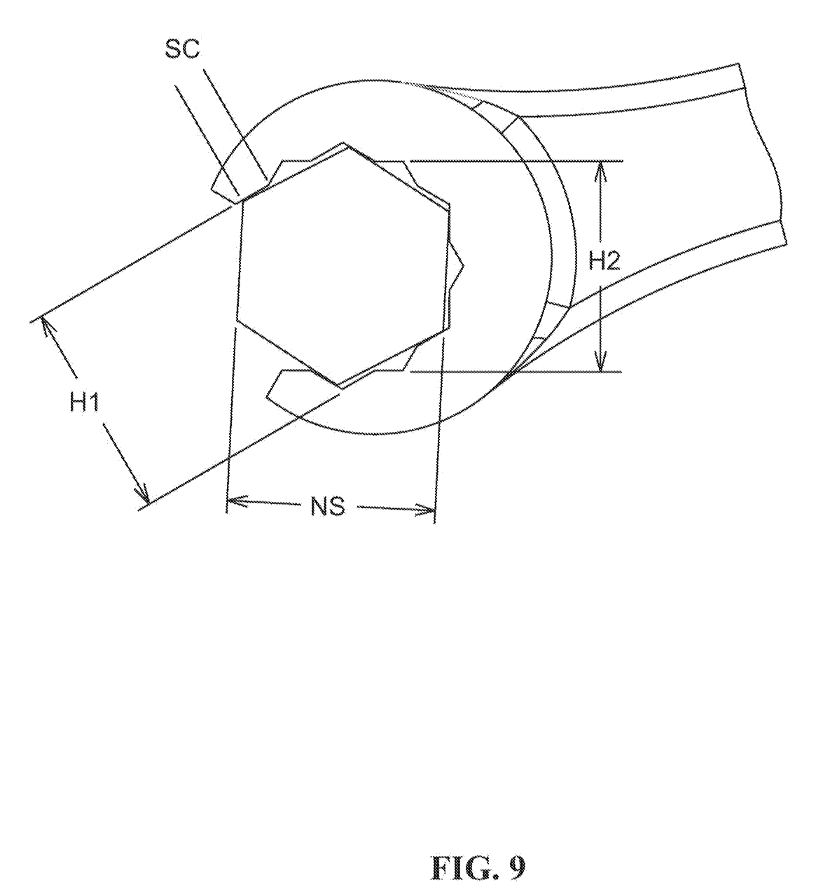

The above dimensions determine what different wrench sizes can be advantageously combined in dual sized wrenches according to the invention. The surface contact areas of facets F of a dual hex wrench need to be large enough to adequately grip and turn a hex nut, and the pockets deep enough not to round the nut vertices. Reducing the hex size HSs of an inner hex pattern reduces its point-to-hex distance PHDs and correspondingly its surface contact length and hence, surface contact area. (Conversely, reducing the hex size HSs of an inner hex pattern increases the outer hex pattern's point-to-hex distance PHDL and correspondingly its surface contact area, as discussed below with reference to FIG. 9.) Preferably, an inner hex pattern H2 preserves at least 80% of the surface contact area of an equal size hex pattern in a standard one size dual hex wrench. In other words, the reduction in point-to-hex distance shown in Column I of FIGS. 5, 6, 7 and 8 preferably does not exceed 20%. An alternate calculation for the minimum preferred practical size HSs of an inner hex pattern is that it preferably use at least 97% of the outer hex size HSL as shown in Column F of FIGS. 5, 6, 7 and 8.

FIG. 5 Column A lists English sizes considered for use as the larger hex pattern with a Column D metric size for the smaller hex pattern in a dual size wrench, and Column J indicates with check marks the combinations of sizes that are suitable. For example, the two similar wrench sizes 11/16 inch and 17 mm are considered in FIG. 5, row 8. The English size 11/16″ (Col. A) is equal to 0.688″ (Col. B) while the metric size 17 mm (Col. D) is equal to 0.669″ (Col. E). 11/16″ is larger so it becomes the outer hex size HSL (Col. A) while 17 mm becomes the inner hex size HSS (Col. D). Applying the above formulas, Inner size HSs uses 97.4% (Col. F) of Outer size HSL, satisfying the 97% preferred minimum and meaning that the Row 8 sizes 11/16 inch and 17 mm are suitable to be combined in a dual sized wrench according to an embodiment of the invention, as indicated by the check mark in Row 8 Column J.

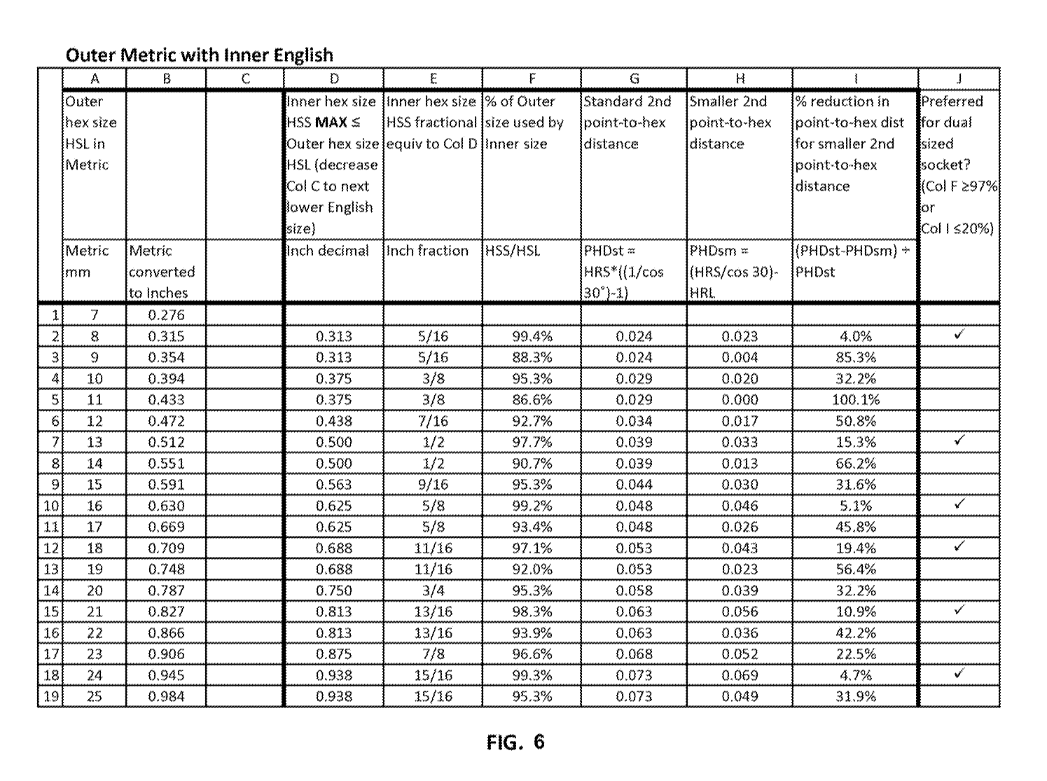

FIG. 6 Column A lists metric sizes considered for use as the larger hex pattern with a Column D English size for the smaller hex pattern in a dual size wrench, while Column J indicates with check marks which combinations of sizes are suitable. For example, referring to FIG. 6 row 7, an outer, first hex pattern H1 may have a width HSL of 13 mm (Col. A) while an inner, second hex pocket H2 has a width HSs of ½″ (Col. E). 13 mm equals 0.512″ (Col. B) so a ½ inch hexagon is only slightly, 0.012″, smaller. The first set of hex pockets is used to turn a 13 mm bolt or nut. The second set of hex pockets is used to turn a ½″ bolt or nut.

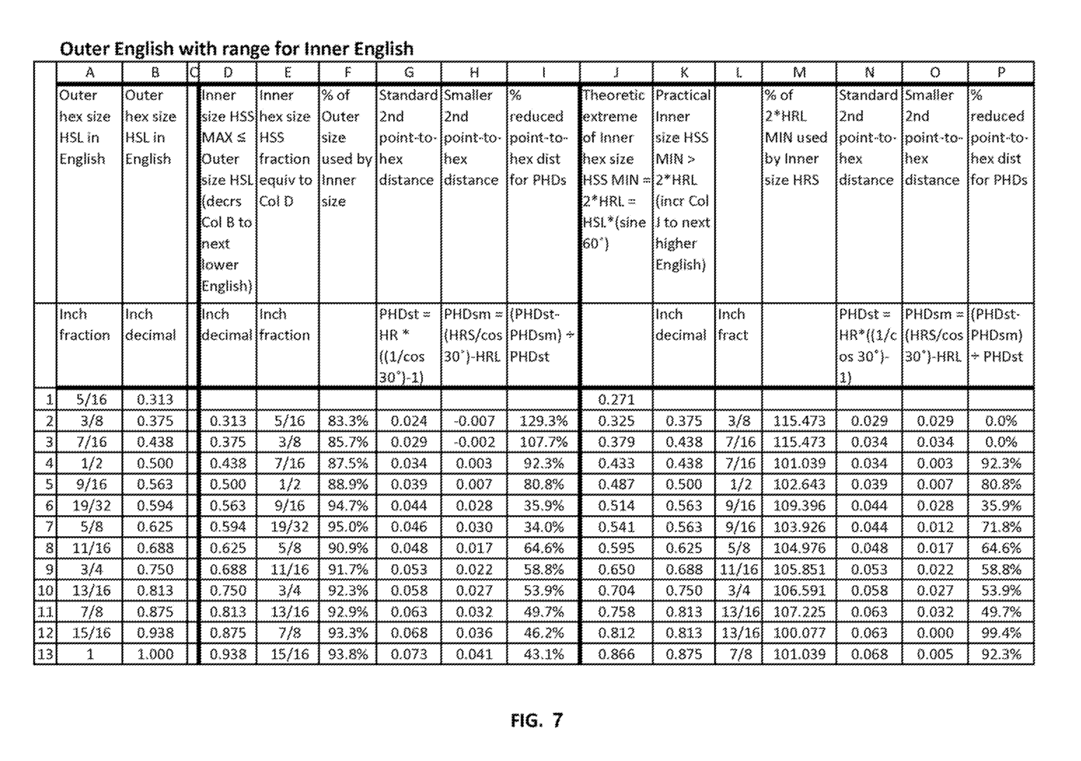

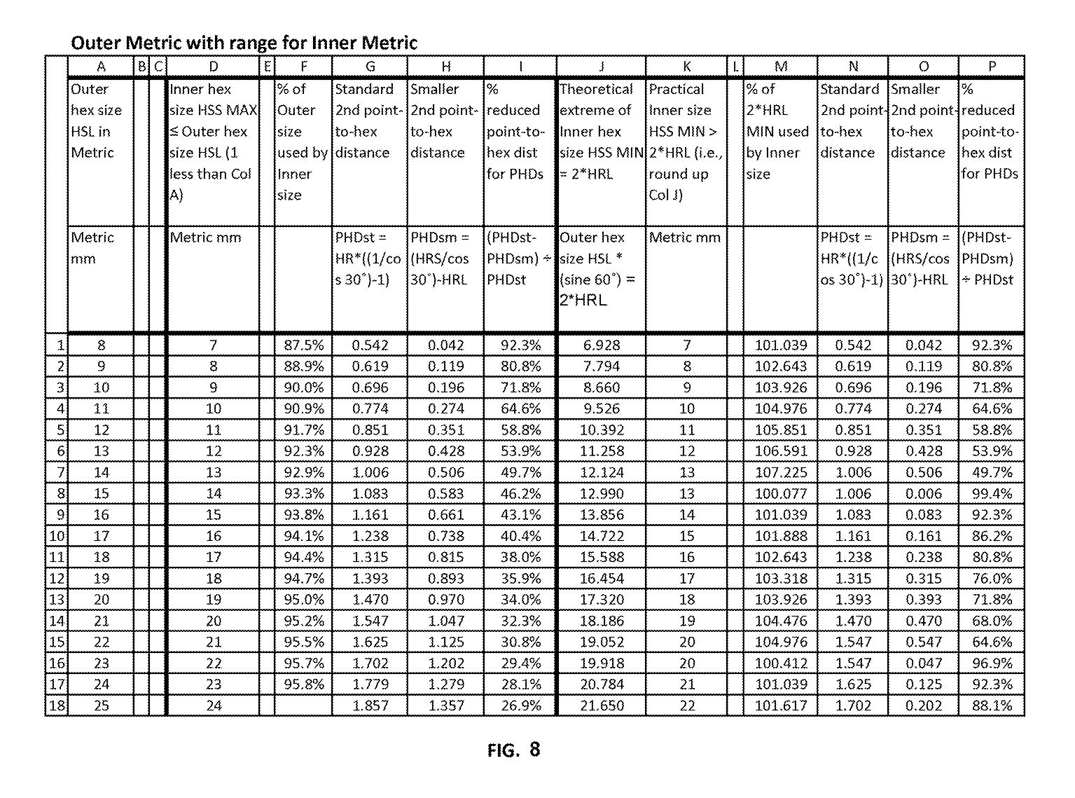

Further, as shown in the tables of FIGS. 7 and 8, two sets of hex pockets could be of two closely spaced English (inch) sizes or two closely spaced metric sizes. FIGS. 7 and 8 do not indicate any possible combinations of English/English or metric/metric sizes yielding at least 97% in Column F or at most 20% in Column P. The difference between 1 1/16 inch and 1⅛ inch wrenches is slight. English/English and metric/metric combinations become more practical on larger wrenches.

As mentioned above, as the inner hex pattern size HSs decreases, the outer hex pattern's point-to-hex distance PHDL, and correspondingly its surface contact length SCL and area, increases beyond the standard first point-to-hex distance HRL. Therefore, as the inner hex H2 gets smaller the gripping ability of the wrench's outer hex H1 gets stronger. Consequently, as shown by FIG. 9, in the FIG. 5 row 8 wrench the increased Surface Contact (SC) area of the outer pattern H1 is better even for a mismatched Nut Size NS=17 mm than is a conventional single sized ( 11/16″) wrench for a mismatch. The strength of the hex pockets is maximized if the two sets of pockets are offset by 30° around axis X, but other offsets are possible.

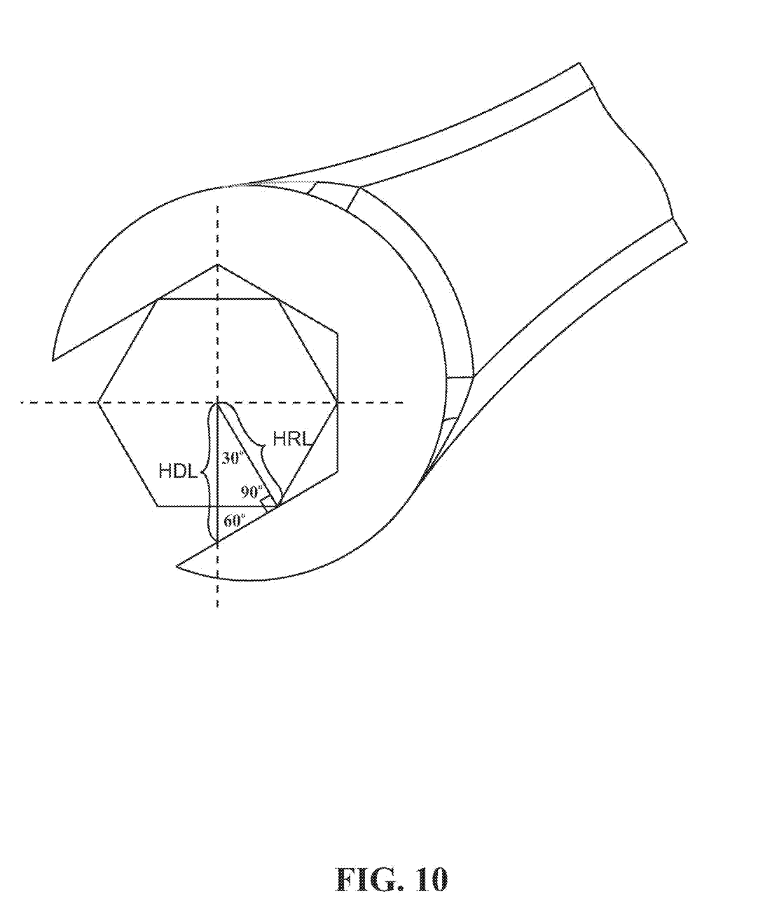

If harder materials were used to fabricate nuts, bolts and wrenches, then the preferred limits of no more than 20% reduction in point-to-hex distance, or that the inner hex size HSs be at least 97% if the outer hex size HSL, might be exceeded to consider dual sizes such as those listed in FIG. 7 rows 7, 9 and 10, and in FIG. 8 rows 8-18. Referring to FIG. 10, the maximum theoretical difference between outer and inner sizes, or the minimum theoretical size of the inner hex pattern, is for the inner hex pattern diagonal HDs to be at least the outer hex pattern radius HRL. HRL is equal to HDL times sine 60°. This extreme of (HDL)*(86.6%) is only approached when the offset between the two hex patterns is 30° around axis X.

While the present invention is described in terms of preferred embodiments, it will be appreciated by those skilled in the art that these embodiments may be modified without departing from the essence of the invention. For example, the principles of the invention could be applied to square-headed nuts and bolts by using offset outer and inner sets of square patterns. It is therefore intended that the following claims be interpreted as covering any modifications falling within the true spirit and scope of the invention.

We claim:

1. A wrench for turning hexagonal nuts and bolts, having a jaw portion formed to fit a first-sized hex nut and, at a different time, a different second-sized hex nut.

2. The wrench of claim 1 wherein the first-sized hex nut is measured in English units and the second-sized hex nut is measured in metric units.

3. The wrench of claim 1 wherein the first-sized hex nut and the second-sized hex nut are different sizes both measured in English units.

4. The wrench of claim 1 wherein the first-sized hex nut and the second-sized hex nut are different sizes both measured in metric units.

5. A wrench for turning hexagonal nuts and bolts, having a jaw portion with a center axis and, around the axis, a cylindrical opening which has, intersected by a plane perpendicular to the axis, some sides along the perimeter of a large size first hexagon and other sides along the perimeter of a smaller size second hexagon which is offset around the axis from the first hexagon.

6. The wrench of claim 5 wherein the second hexagon is offset by 30 degrees around the axis from the first hexagon.

7. The wrench of claim 6 wherein the first hexagon has opposing faces at a distance HSL and the second hexagon has opposing faces at a distance HSs which is greater than sine 60° times HSL.

8. The wrench of claim 7 wherein distance HSs is at least 97% of distance HSL.

9. The wrench of claim 7 wherein the reduction in Point-to-Hex distance PHDs for the second hexagon pattern compared to a hexagon pattern of the same size HSs in a single size wrench is ≦20%.

10. A wrench tool that has a first square opening sized to metric dimensions and, rotationally offset from the first opening, a second square opening sized to English dimensions.
